(19) United States
(12) Patent Application Publication
(10) Pub. No.: US 2010/0321309 A1
(43) Pub. Date: Dec. 23, 2010

(54) TOUCH SCREEN AND TOUCH MODULE

(75) Inventors: Chi-Feng Lee, Hsinchu County (TW); Pei-Hui Tung, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: SONIX TECHNOLOGY CO., LTD., Hsinchu (TW)

(21) Appl. No.: 12/545,871

(22) Filed: Aug. 24, 2009

(30) Foreign Application Priority Data
Jun. 22, 2009 (TW) 98120875

(51) Int. Cl. G06F 3/041

(52) U.S. Cl. 345/173

(57) ABSTRACT

A touch screen including a display, at least two touch units and a control unit is provided. The display has a displaying surface. The touch units are disposed beside the displaying surface. Each of the touch units includes a light source and an image sensor. The light source is adapted to emit a light beam toward a sensible space in front of the displaying surface. The image sensor is adapted to capture the bright spot in the sensible space, and generate an image signal. The control unit is electrically connected to the light sources and the image sensors. The control unit is adapted to receive the image signals from the image sensors, and determine the position of the bright spot relative to the displaying surface according to the image signals. A touch module and a control method are also provided.

### CROSS-REFERENCE TO RELATED APPLICATION

This application claims the priority benefit of Taiwan application serial no. 98120875, filed on Jun. 22, 2009. The entirety of the above-mentioned patent application is hereby incorporated by reference herein and made a part of specification.

### BACKGROUND OF THE INVENTION

1. Field of the Invention

The present invention generally relates to a touch module and a touch screen, and more particularly, to an optical touch module and an optical touch screen.

2. Description of Related Art

With the development of optoelectronic technology, it can not satisfy a user's requirement to control the operating platform and objects in the screen by using a mouse. Accordingly, an interface more humanistic than the mouse is gradually developed. In these humanistic interfaces, the touch method by using fingers is closest to human experience in the daily life. Accordingly, elders and children may not use the mouse, but they can touch with fingers easily. It has been partially proved that the touch screen is adapted in ATM. A plurality of methods in which touch interfaces are realized are provided in related arts. For example, a touch film is adhered to the panel of the liquid crystal display (LCD) in the related art, so that a resistive touch screen or a capacitive touch screen is provided. Alternatively, a tiny touch device may be integrated in the liquid crystal panel in another related art. However, the touch film adhered to the panel and the tiny touch device integrated in the panel both affect light transmittance of the LCDs. Accordingly, optical quality of the LCDs is reduced. Moreover, the position of the finger or the touch pen relative to the screen is determined by using optically sensing method in another related art. However, in the above-described related art, the position of the finger is determined by capturing dark spots which are formed due to the finger or the touch pen screening light beams. However, in order to exactly identify the dark spots and reduce failure rate, a good and uniform back light source is required, so that the dark spots are more obvious than the back light source. The back light source is provided by adhering reflecting bars and light emitting bars to edges of the displaying surface of the screen, but it may simultaneously increase complexity and cost of assembly. Furthermore, it is easily affected by environment light beams to capture the dark spots. Specifically, when the environment light beams illuminate the finger or the touch pen and are reflected to image sensors, the dark spots are not identified.

### SUMMARY OF THE INVENTION

An embodiment of the present invention provides a touch module of which a structure is simple and has low failure rate.

An embodiment of the present invention provides a touch screen having low failure rate.

An embodiment of the present invention provides a touch module adapted for a display, so that the display has a touch function. The display has a displaying surface, and the touch module includes a first image sensor, a second image sensor, and a control unit. The first image sensor is disposed at a first position beside the displaying surface. The second image sensor is disposed at a second position beside the displaying surface. The control unit is electrically connected to a light source, the first image sensor, and the second image sensor. When at least one touch object enters a sensing space in front of the displaying surface, the first image sensor and the second image sensor sense a light beam reflected by the at least one touch object, and the control unit is adapted to determine a position of the touch object relative to the displaying surface according to the light beam reflected by the touch object and sensed by the first image sensor and the second image sensor.

In an embodiment of the present invention, the touch module further includes at least one light source disposed beside the displaying surface and adapted to emit the light beam entering the sensing space.

In an embodiment of the present invention, the above-described light source includes a first light source and a second light source which are respectively disposed at a third position and a fourth position beside the displaying surface. The control unit is adapted to continuously control the first light source and the second light source in a plurality of continuous unit times. Each of the unit times includes a first sub-unit time and a second sub-unit time. The control unit is adapted to control the first light source to stay at an ON state and the second light source to stay at an OFF state in the first sub-unit time. The control unit is adapted to control the first light source to stay at the OFF state and the second light source to stay at the ON state in the second sub-unit time.

In an embodiment of the present invention, the control unit is adapted to control the first image sensor to stay at the ON state and the second image sensor to stay at the OFF state in the first sub-unit time. The control unit is adapted to control the first image sensor to stay at the OFF state and the second image sensor to stay at the ON state in the second sub-unit time.

In an embodiment of the present invention, each of the unit times further includes a third sub-unit time. The control unit is adapted to control the first light source and the second light source to stay at the OFF state in the third sub-unit time. The control unit is adapted to subtract an image brightness sensed by the first image sensor in the third sub-unit time of each of the unit times from an image brightness sensed by the first image sensor in the first sub-unit time of the corresponding unit time to obtain a first touch image. The control unit is adapted to subtract an image brightness sensed by the second image sensor in the third sub-unit time of each of the unit times from an image brightness sensed by the second image sensor in the second sub-unit time of the corresponding unit time to obtain a second touch image. The control unit determines the position of the touch object relative to the displaying surface according to the first touch image and the second touch image.

In an embodiment of the present invention, the third position and the fourth position are respectively located at two neighboring corners of the displaying surface. The first position and the third position are respectively located beside a same corner of the displaying surface, and the second position and the fourth position are respectively located beside a same corner of the displaying surface.

In an embodiment of the present invention, the touch module further includes a third image sensor and a fourth image sensor which are respectively disposed at a fifth position and a sixth position beside the displaying surface. Sensing surfaces of the third image sensor and the fourth image sensor face to the sensing space. The light source further includes a third light source and a fourth light source which are respectively disposed at a seventh position and an eighth position beside the displaying surface. Each of the unit times includes a fourth sub-unit time and a fifth sub-unit time. The control unit is adapted to control the third light source and the fourth light source to stay at the OFF state in the first sub-unit time. The control unit is adapted to control the third light source and the fourth light source to stay at the OFF state in the second sub-unit time. The control unit is adapted to control the third light source to stay at the ON state and the first light source, the second light source, and the fourth light source to stay at the OFF state in the fourth sub-unit time. The control unit is adapted to control the fourth light source to stay at the ON state and the first light source, the second light source, and the third light source to stay at the OFF state in the fifth sub-unit time.

In an embodiment of the present invention, the number of the touch objects, for example, is two. When the touch objects are simultaneously located in the sensing space in at least one of the unit times, the touch images sensed by the first image sensor, the second image sensor, the third image sensor, and the fourth image sensor each have at least one reflex point, and the touch images sensed by at least two of the first image sensor, the second image sensor, the third image sensor, and the fourth image sensor each have two reflex points in the unit times. The control unit is adapted to compare positions of the reflex points in the touch images to eliminate the positions of the touch objects relative to the displaying surface which do not exist and determine the positions of the touch objects relative to the displaying surface.

In an embodiment of the present invention, the first image sensor and the second image sensor are maintained at the ON state all the time in each of the unit times.

In an embodiment of the present invention, the first position and the second position are respectively located at two neighboring corners of the displaying surface.

In an embodiment of the present invention, the touch module further includes at least one absorbing bar or at least one light-turning bar which is disposed on at least one edge of the displaying surface, wherein the light-turning bar is adapted to reflect the light beam to a direction away from the displaying surface.

Another embodiment of the present invention provides a touch module adapted for a display, so that the display has a touch function. The display has a displaying surface, and the touch module includes a first light source, a second light source, a first image sensor, a second image sensor, and a control unit. The first image sensor is disposed at a first position beside the displaying surface. The second image sensor is disposed at a second position beside the displaying surface. The first light source is disposed at a third position beside the displaying surface and adapted to emit a light beam entering a sensing space in front of the displaying surface. The second light source is disposed at a fourth position beside the displaying surface and adapted to emit a light beam entering the sensing space. The control unit is electrically connected to the first light source, the second light source, the first image sensor, and the second image sensor. The control unit is adapted to continuously control the first light source and the second light source in a plurality of continuous unit times. Each of the unit times includes a first sub-unit time and a second sub-unit time. The control unit is adapted to control the first light source to stay at an ON state and the second light source to stay at an OFF state in the first sub-unit time. The control unit is adapted to control the first light source to stay at the OFF state and the second light source to stay at the ON state in the second sub-unit time. When at least one touch object enters the sensing space, the first image sensor and the second image sensor sense an image of the at least one touch object, and the control unit is adapted to determine a position of the at least one touch object relative to the displaying surface according to the image sensed by the first image sensor and the second image sensor.

Another embodiment of the present invention provides a touch screen which includes a display, at least two touch units, and a control unit. The display has a displaying surface. The touch units are disposed beside the displaying surface, and each of the touch units includes a light source and an image sensor. The light source are disposed beside the displaying surface and adapted to emit a light beam entering a sensing space in front of the displaying surface. The image sensor is disposed beside the displaying surface, and a sensing surface of the image sensor faces to the sensing space, wherein the image sensor is adapted to capture a bright spot in the sensing space and generate an image signal. The control unit is electrically connected to the light sources and the image sensors, wherein the control unit is adapted to receive the image signals from the image sensors and determine a position of the bright spot relative to the displaying surface according to the image signals.

In an embodiment of the present invention, the control unit is adapted to drive the light sources of the touch units by turns.

In an embodiment of the present invention, after driving the light source of one of the touch units and before driving the light source of another one of the touch units, the control unit is adapted to maintain the light sources of the touch units at an OFF state. The control unit is adapted to subtract an image brightness sensed by the image sensor of each of the touch units while the light source of the same touch unit is maintained at the OFF state from an image brightness sensed by the same image sensor thereof while the same light source is driven to obtain a touch image, and the control unit determines the position of the bright spot relative to the displaying surface according to the touch image.

In an embodiment of the present invention, the control unit includes at least two signal processors and a back-end processor. The signal processors are electrically connected to the image sensors of the touch units respectively, wherein each of the signal processors is adapted to determine the position of the bright spot according to the image sensed by the corresponding image sensor and generate a one-dimensional coordinate signal. The back-end processor is electrically connected to the signal processors, wherein the back-end processor is adapted to receive the one-dimensional coordinate signals generated by the signal processors and determine the position of the bright spot relative to the displaying surface according to the one-dimensional coordinate signals.

In an embodiment of the present invention, the control unit is adapted to control the image sensor to repeatedly capture the bright spot in the sensing space and determine a position change of the bright spot according thereto.

In the touch screen and the touch module in the embodiments of the present invention, the image sensor is used to capture the bright spot, i.e. the light beam reflected by the touch object. Compared with the touch module in which capturing a dark spot, i.e. a light shading spot, is adopted, and a good back light source is formed by disposing reflecting bars and light emitting bars on edges of the displaying surface, the structures of the touch screen and the touch module in the embodiments of the present invention are simpler. Accordingly, it can reduce cost of the touch screen and the touch module, and the touch screen is beautiful.

Moreover, the light sources are controlled to stay at the ON state by turns in the touch module and the touch screen in the embodiments of the present invention. Accordingly, it is avoided that the image sensors are interfered with light beams emitted by unnecessary light sources. Therefore, the touch module and the touch screen in the embodiments of the present invention have low failure rate.

To make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a front view of a touch screen and an operating platform according to an embodiment of the present invention.

FIG. 1B is a schematic cross-sectional view of the touch screen in FIG. 1A along line I-I.

FIG. 1C is an enlarged view of touch units in FIG. 1A.

FIG. 2A is a driving period distribution of the control unit in FIG. 1A.

FIG. 2B is a flowchart of a control method of the touch module shown in FIG. 1A.

FIG. 3A is a front view of a touch screen and an operating platform according to another embodiment of the present invention.

FIG. 3B is a schematic cross-sectional view of the touch screen in FIG. 3A along line II-II.

FIG. 4A is a driving period distribution of the control unit in FIG. 3A.

FIG. 4B is a flowchart of a control method of the touch module shown in FIG. 3A.

FIG. 5A is a front view of a touch screen and an operating platform according to another embodiment of the present invention.

FIG. 5B is a schematic cross-sectional view of the touch screen in FIG. 5A along line III-III.

FIG. 5C is another view of the touch screen in FIG. 5B.

FIG. 6A is a front view of a touch screen and an operating platform according to another embodiment of the present invention.

FIG. 6B is a schematic cross-sectional view of the touch screen in FIG. 6A along line IV-IV.

FIG. 7 is a front view of a touch screen and an operating platform according to another embodiment of the present invention.

FIG. 8A is a driving period distribution of the control unit in FIG. 7.

FIG. 8B is a flowchart of a control method of the touch module shown in FIG. 7.

FIG. 9 is a front view of a touch screen and an operating platform according to another embodiment of the present invention.

### DESCRIPTION OF EMBODIMENTS

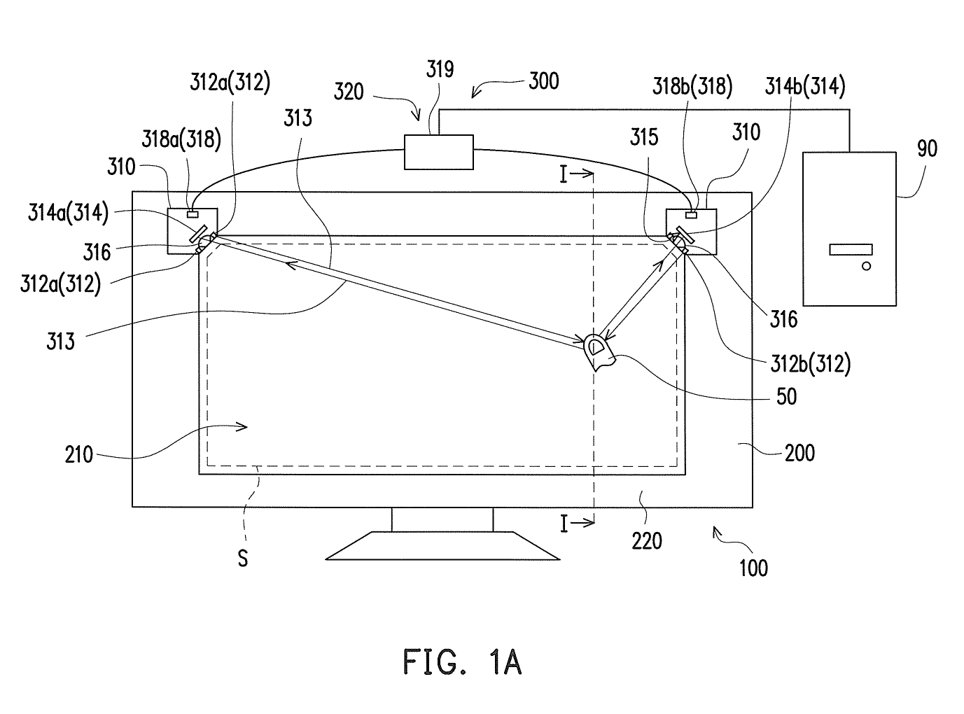

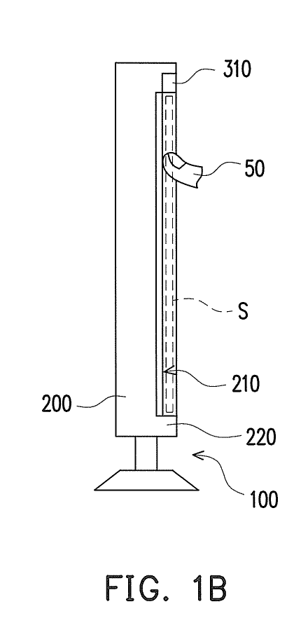

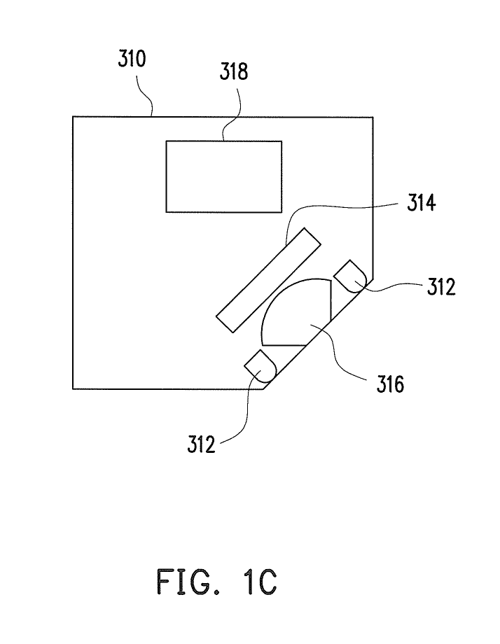

FIG. 1A is a front view of a touch screen and an operating platform according to an embodiment of the present invention. FIG. 1B is a schematic cross-sectional view of the touch screen in FIG. 1A along line I-I. FIG. 1C is an enlarged view of touch units in FIG. 1A. Referring to FIG. 1A, FIG. 1B, and FIG. 1C, the touch screen 100 of the present embodiment includes a display 200, at least two touch units 310, and a control unit 320. In the present embodiment, the touch units 310 and control unit 320 may compose of a touch module 300. The display 200 has a displaying surface 210. In the present embodiment, the touch units 310 is disposed beside the displaying surface 210, and each of the touch units 310 includes at least one light source 312 and an image sensor 314. In FIG. 1A, the number of the light sources 312, for example, is two. In other words, in the present embodiment, the touch module 300 includes at least one light source 312, a first image sensor 314a, a second image sensor 314b, and a control unit 320.

The light source 312 are disposed beside the displaying surface 210 and adapted to emit a light beam 313 entering a sensing space S in front of the displaying surface 210. The image sensor 314 is disposed beside the displaying surface 210. In the present embodiment, a sensing surface 315 of the image sensor 314 faces to the sensing space S. In the present embodiment, a traveling direction of the light beam 313 is substantially parallel to the displaying surface 210, and the sensing space S is defined as a space in front of the displaying surface 210 in which the light beam 313 travels and is sensed by the image sensor 314. A position and a scope thereof, for example, is shown in a dotted line in FIG. 1A and FIG. 1B. Moreover, in the present embodiment, the first image sensor 314a is disposed at a first position beside the displaying surface 210 as shown in FIG. 1A, and the second image sensor 314b is disposed at a second position beside the displaying surface 210 as shown in FIG. 1A.

In the present embodiment, the image sensor 314 is adapted to capture a bright spot in the sensing space S and generate an image signal. Specifically, when at least one touch object 50, i.e. a finger in FIG. 1A, enters the sensing space S, the first image sensor 314a and the second image sensor 314b sense the light beam 313 reflected by the touch object 50, and an image of the touch object 50 imaged on the image sensor 314 is a bright spot. In the present embodiment, an imaging device 316 is disposed in front of the image sensor 314 to image the light beam 313 reflected by the touch object 50 on the image sensor 314, wherein the imaging device 316, for example, is a lens or a pin hole.

In the present embodiment, the control unit 320 is electrically connected to the light sources 312 and the image sensors 314, wherein the control unit 320 is adapted to receive the image signals from the image sensors 314 and determine a position of the bright spot relative to the displaying surface 210 according to the image signals. In other words, in the present embodiment, the control unit 320 is adapted to determine a position of the touch object 50 relative to the displaying surface 210 according to the light beam 313 reflected by the touch object 50 and sensed by the first image sensor 314a and the second image sensor 314b. In the present embodiment, the light sources 312, for example, are light emitting diodes (LEDs), laser diodes, or other light emitting devices, and the light beam 313, for example, is an infrared ray (IR), a visible light beam, a laser beam, or an electromagnetic radiating wave having wavelengths in a suitable range. However, the present invention is not limited thereto. Furthermore, the touch object 50, for example, is a user's finger or a tip of a touch pen.

In the present embodiment, the control unit 320 includes at least two signal processors 318 and a back-end processor 319. In FIG. 1A, the at least two signal processors 318, for example, are two signal processors 318a and 318b. The signal processors 318 are electrically connected to the image sensors 314 of the touch units 310 respectively. That is, the signal processors 318a and 318b are electrically connected to the first image sensor 314a and the second image sensor 314b respectively. Each of the signal processors 318 is adapted to determine the position of the bright spot according to the image sensed by the corresponding image sensor 314 and generate a one-dimensional coordinate signal. The one-dimensional coordinate signal, for example, is an incident angle of the light beam 313 reflected by the touch object 50 and entering the image sensor 314. The back-end processor 319 is electrically connected to the signal processors 318, wherein the back-end processor 319 is adapted to receive the one-dimensional coordinate signals generated by the signal processors 318 and determine the position of the bright spot relative to the displaying surface 210 according to the one-dimensional coordinate signals. Specifically, the back-end processor 319 calculates the position of the bright spot relative to the displaying surface 210 according to two incident angles of the light beam 313 respectively entering the two different image sensors 314. In the present embodiment, after calculating the position of the bright spot relative to the displaying surface 210, the back-end processor 319 transmits a position signal to the operating platform 90 connected with the back-end processor 319, so that the operating platform 90 determines the position of the touch object relative to a frame displayed on the displaying surface 210. Accordingly, the touch function is provided. In the present embodiment, the operating platform 90, for example, is a computer. However, in other embodiments, the operating platform 90 may be a cell phone, a personal digital assistant (PDA), a digital camera, or another suitable electrical control system or electrical device.

It should be noted that, the present invention is not limited to the arrangement of the signal processors 318 and the back-end processor 319, such as the disposition and the assembly. For example, in the present embodiment, the signal processors 318 are assembled in the touch unit 310 and electrically connected with the back-end processor 319 through transmission lines. However, in other embodiments, the signal processors 318 and the back-end processor 319 may be integrated in the same chip. Alternatively, one of the signal processors 318a and 318b and the back-end processor 319 may be integrated in the same chip, and the other thereof may be electrically connected with the chip through the transmission lines. Alternatively, the back-end processor 319 may be integrated in the processor of the operating platform 90. That is, the operation of the back-end processor 319 is provided by using the program and the processor of the operating platform.

In the present embodiment, the light sources 312 include at least one first light source 312a, e.g. two first light sources 312a shown in FIG. 1A, and at least one second light source 312b, e.g. two second light sources 312b shown in FIG. 1A, which are respectively disposed at a third position and a fourth position, e.g. the positions shown in FIG. 1A, beside the displaying surface. In the present embodiment, the third position and the fourth position are respectively located at two neighboring corners of the displaying surface 210. The first position and the third position are respectively located beside a same corner of the displaying surface 210, and the second position and the fourth position are respectively located beside a same corner of the displaying surface 210. Furthermore, the first position and the second position may be respectively located at two neighboring corners of the displaying surface 210. In other words, in the present embodiment, the first light source 312a and the first image sensor 314a are combined in one of the two touch units 310, and the second light source 312b and the second image sensor 314b are combined in the other of the two touch unit 310. Moreover, the two touch units 310 are respectively located at two neighboring corners of the displaying surface 210.

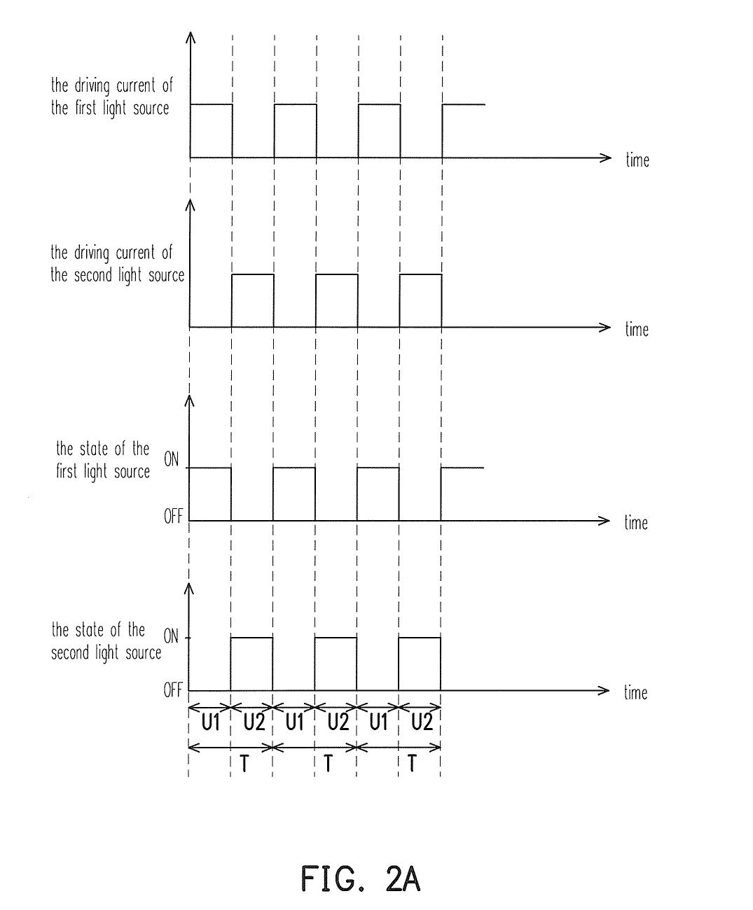

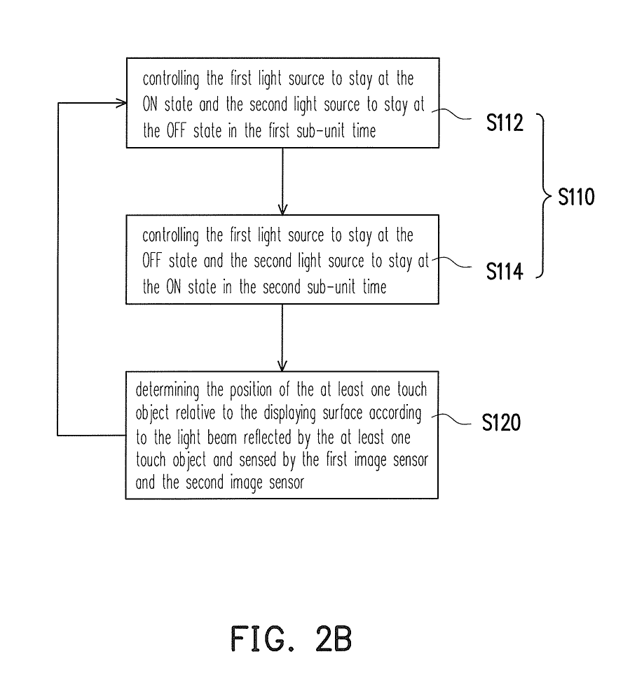

FIG. 2A is a driving period distribution of the control unit in FIG. 1A. Referring to FIG. 1A through FIG. 1C and FIG. 2A, in the present embodiment, the control unit 320 is adapted to drive the light sources 312 of the touch units 310 by turns. Specifically, the control unit is adapted to continuously control the first light source 312a and the second light source 312b in a plurality of continuous unit times T. Each of the unit times T includes a first sub-unit time U1 and a second sub-unit time U2. The control unit 320 is adapted to control the first light source 312a to stay at an ON state and the second light source 312b to stay at an OFF state in the first sub-unit time U1. In other words, as shown in FIG. 2A, the first light source 312a is driven by a current, and a current passing through the second light source 312b is controlled to be substantially equal to zero in the first sub-unit time U1. The control unit 320 is adapted to control the first light source 312a to stay at the OFF state and the second light source 312b to stay at the ON state in the second sub-unit time U2. In other words, as shown in FIG. 2A, the current passing through the first light source 312a is controlled to be substantially equal to zero, and the second light source 312b is driven by the current in the second sub-unit time U2. It should be noted that, the waveform of the driving currents is a square wave as an example. However, in other embodiments, the waveform of the driving currents may be a sine wave, a triangle wave, a circle wave, a wave having a horizontally asymmetric waveform, a wave having a regular waveform, or a wave having an irregular waveform.

In the present embodiment, the control unit 320 is adapted to control the first image sensor 314a to stay at the ON state and the second image sensor 314b to stay at the OFF state in the first sub-unit time U1, as shown in FIG. 2A. Moreover, the control unit 320 is adapted to control the first image sensor 314a to stay at the OFF state and the second image sensor 314b to stay at the ON state in the second sub-unit time U2. It should be noted that, the ON state and the OFF state at which the image sensors are respectively mean that the image sensors are substantially turned on and that the image sensors are substantially turned off. Alternatively, they may respectively mean that the data is available and that the data is unavailable.

As a result, when the first image sensor 314a is turned on in the first sub-unit time U1, the first image sensor 314a senses the reflected light beam 313 emitted by the first light source 312a instead of the light beam 313 emitted by the second light source 312b which directly enters the first image sensor 314a or is reflected and transmitted to the first image sensor 314a. Accordingly, the first image sensor 314a is not interfered with the second light source 312b. On the contrary, when the second image sensor 314b is turned on in the second sub-unit time U2, the second image sensor 314b senses the reflected light beam 313 emitted by the second light source 312b instead of the light beam 313 emitted by the first light source 312a which directly enters the second image sensor 314b or is reflected and transmitted to the second image sensor 314b. Accordingly, the second image sensor 314b is not interfered with the first light source 312a. Since the image sensor 314 is not interfered with the light source 312 of the different touch unit 310, the touch screen 100 and the touch module 300 thereof have low failure rate in the present embodiment.

It should be noted that, the arrangement and the periods of the first sub-unit time U1 and the second sub-unit time U2 in the unit time T do not limit the present invention. For example, in other embodiments, the second sub-unit time U2 may be arranged prior to the first sub-unit time U1. Alternatively, the first sub-unit time U1 and the second sub-unit time U2 may be adjacent to each other or not, and the first sub-unit time U1 and the second sub-unit time U2 may not fully fill the unit time T. Moreover, it does not limit the present invention that the first image sensor 314a and the second image sensor 314b are alternatively turned on. In other embodiments, the first image sensor 314a and the second image sensor 314b may be both maintained at the ON state all the time in each of the unit times T. The control unit 320, for example, is adapted to obtain a sensed result of the first image sensor 314a to analyze in the first sub-unit time U1. That is, the data of the first image sensor 314a is available, but the data of the second image sensor 314b is unavailable in the first sub-unit time U1. Meanwhile, the control unit 320 is adapted to obtain a sensed result of the second image sensor 314b to analyze in the second sub-unit time U2. That is, the data of the second image sensor 314b is available in the second sub-unit time U2, but the data of the first image sensor 314a is unavailable. As a result, even if the image sensors 314 are not turned off at the right moment, a determined result of the control unit 320 for the position of the touch object is not affected.

In the touch screen 100 and the touch module 300 of the present embodiment, the image sensors 314 are used capture the bright spot, i.e. the light beam reflected by the touch object 50. Compared with the touch module in which capturing the dark spot, i.e. the light shading spot, is adopted, and the good back light source is formed by disposing the reflecting bars and the light emitting bars on the edges of the displaying surface, the reflecting bars and the light emitting bars are not required by the touch screen 100 and the touch module 300 in the embodiment, so that the structures thereof are simpler. Accordingly, it can reduce cost of the touch screen 100 and the touch module 300, and the touch screen 100 is beautiful. Moreover, the touch module 300 of the present embodiment is disposed beside the displaying surface 210, so that the light beams emitted from the displaying surface 210 are not screened. Compared with the displaying surface in the related art which is covered by a touch film, so that optical quality of the display using the same is affected, the touch module 300 of the present embodiment does not affect optical quality of the display 200. Accordingly, the touch screen 100 of the present embodiment has better optical quality.

Furthermore, in the present embodiment, the control unit 320 is adapted to control the image sensor 314 to repeatedly capture the bright spot in the sensing space S and determine a position change of the bright spot according thereto. As a result, the operating platform 90 can obtain the movement of the touch object 50, so that a drag function similar to a mouse is provided.

It should be noted that, it does not limit the present invention that the touch module 300 has the light sources 312. In other embodiments, the touch module 300 may not have the light sources 312, and the light beam 313 is provided by other light sources, such as the light sources or the reflected light beams in the environment.

FIG. 2B is a flowchart of a control method of the touch module shown in FIG. 1A. Referring to FIG. 1A, FIG. 2A, and FIG. 2B, the touch module 300 shown in FIG. 1A is adapted to be controlled by using the control method of the present embodiment, and the control method is performed via the control unit 320. The control method of the present embodiment includes following steps. First of all, when at least one touch object 50 enters the sensing space S, the first image sensor 314a and the second image sensor 314b are controlled to sense the light beam 313 reflected by the touch object 50 in step S110. In the present embodiment, one touch object 50 is exemplary. In the present embodiment, step S100 includes steps S112 and S114. In step S112, the first light source 312a is controlled to stay at the ON state, and the second light source 312b is controlled to stay at the OFF state in the first sub-unit time U1. In step S114, the first light source 312a is controlled to stay at the OFF state, and the second light source 312b is controlled to stay at the ON state in the second sub-unit time U2. In the present embodiment, after step S112, step S114 is performed. In other embodiments, they may be changed in order.

In step S112, the control method of the present embodiment further includes that the first image sensor 314a is controlled to stay at the ON state and the second image sensor 314b is controlled to stay at the OFF state. Moreover, in step S114, the control method of the present embodiment further includes that the first image sensor 314a is controlled to stay at the OFF state and the second image sensor 314b is controlled to stay at the ON state. However, in other embodiments, the first image sensor 314a and the second image sensor 314b may be maintained at the ON state all the time in each of the unit times.

Next, in step S120, the position of the touch object 50 relative to the displaying surface 210 is determined according to the light beam 313 reflected by the touch object 50 and sensed by the first image sensor 314a and the second image sensor 314b.

Thereafter, steps S110 and S120 may be repeated, so that the position change of the touch object 50 is sensed.

It is adopted in the control method of the present embodiment to sense the bright spot, i.e. a reflex point of the touch object 50. Compared with capturing the dark spot, i.e. the light shading spot, in the related art in which the reflecting bars and the light emitting bars are required, the reflecting bars and the light emitting bars are not required in the control method of the present embodiment. Accordingly, it can simplify the structure of the touch module 300. Moreover, since the light sources 312 are alternatively turned on in the control method of the present embodiment, the image sensor 314 is not interfered with the light source 312 of the different touch unit 310, so that lower failure rate is provided in the control method of the present embodiment.

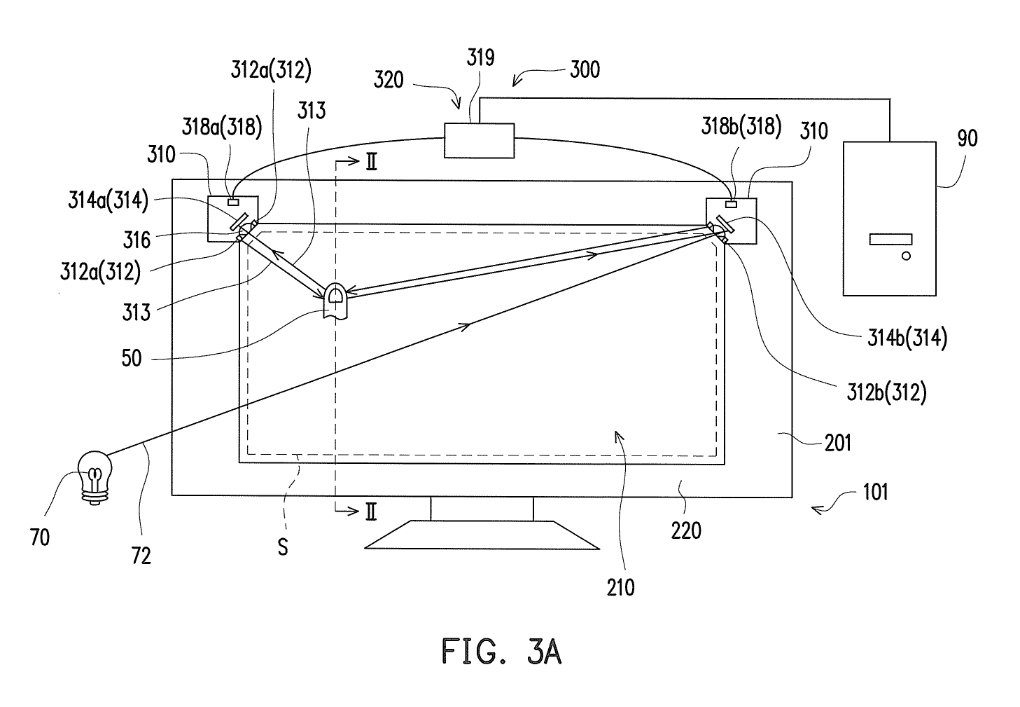

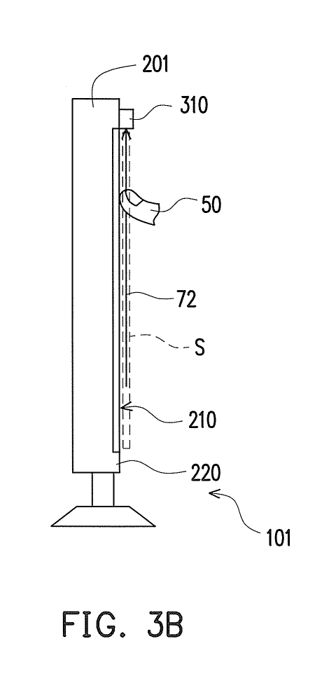

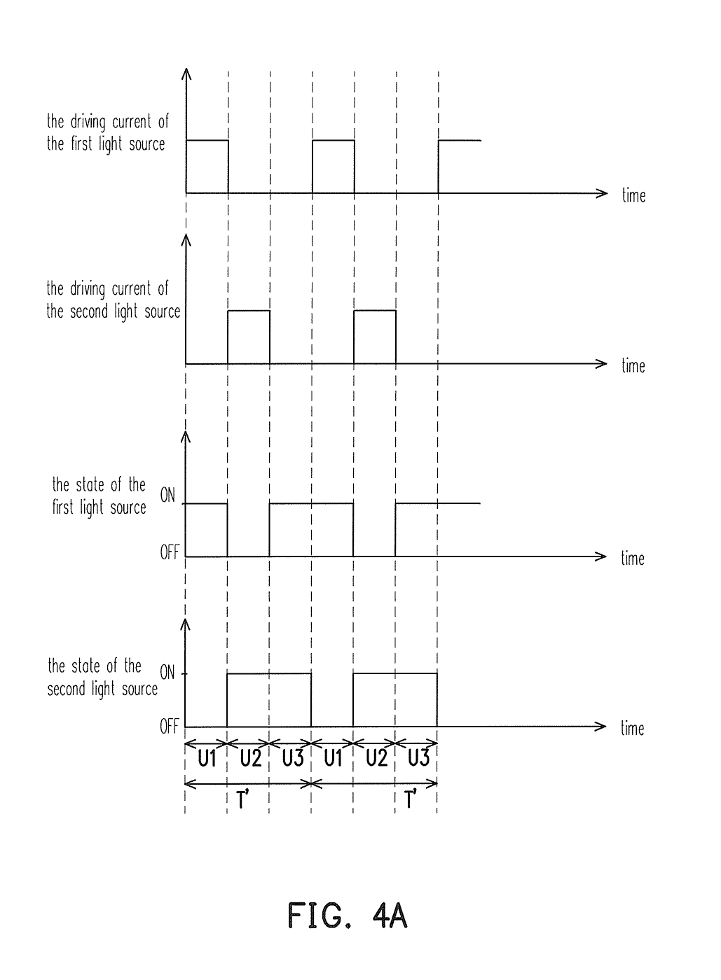

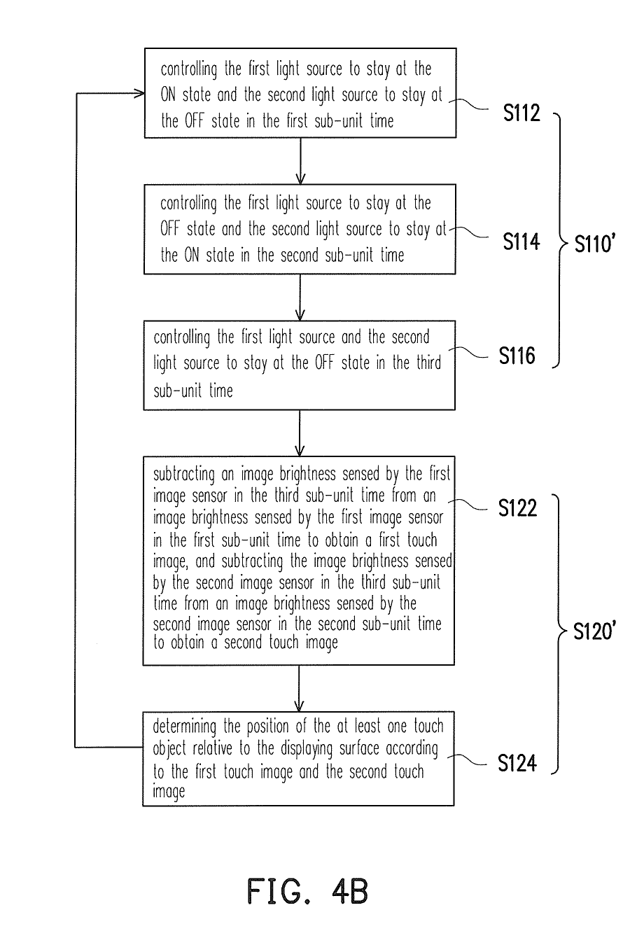

FIG. 3A is a front view of a touch screen and an operating platform according to another embodiment of the present invention. FIG. 3B is a schematic cross-sectional view of the touch screen in FIG. 3A along line II-II. FIG. 4A is a driving period distribution of the control unit in FIG. 3A. Referring to FIG. 3A, FIG. 3B, and FIG. 4A, the touch screen 101 of the present embodiment is similar to the said touch screen 100 (as illustrated in FIG. 1A and FIG. 1B), and the difference between these two touch screens is described as below. In the touch screen 100 shown in FIG. 1B, the displaying surface 210 is recessed with respect to a frame 220 of the display 200. However, in touch screen 101 of the present embodiment, surfaces of the displaying surface 210 and the frame 220 are substantially on the same plane. When the display 201 is used, an environment light beam 72 emitted by an environment light source 70, such as an emitted light beam or a reflected light beam, easily interferes with the sensing results of the image sensors 314. In order to solve the issue, each of the unit times T′ further includes a third sub-unit time U3 in the present embodiment. In the third sub-unit time U3, the control unit 320 is adapted to control the first light source 312a and the second light source 312b to stay at the OFF state. The control unit 320 is adapted to subtract an image brightness sensed by the first image sensor 314a in the third sub-unit time U3 of each of the unit times T′ from an image brightness sensed by the first image sensor 314a in the first sub-unit time U1 of the corresponding unit time T′ to obtain a first touch image. The control unit 320 is adapted to subtract an image brightness sensed by the second image sensor 314b in the third sub-unit time U3 of each of the unit times T′ from an image brightness sensed by the second image sensor 314b in the second sub-unit time U2 of the corresponding unit time T′ to obtain a second touch image. The control unit 320 determines the position of the touch object 50 relative to the displaying surface 210 according to the first touch image and the second touch image. In other words, in the third sub-unit time U3, the first image sensor 314a and the second image sensor 314b both stay at the ON state. However, in other embodiments, the third sub-unit time U3 may be divided into two different sub-unit times, and the first image sensor 314a and the second image sensor 314b are respectively turned on during the two different sub-unit times.

Through the said subtraction of the two image brightness performed by the control unit 320, the image due to the environment light beam 72 is eliminated, so that the exact position of the touch object 50 is obtained without being interfered with the environment light beam 72. The said touch module 300 may be applied to a projection screen. Since the projection screen has no frame, it is easily interfered with the environment light beam 72. Accordingly, the said issues can be effectively solved in the touch module 300 of the present embodiment. Furthermore, the touch module 300 of the present embodiment may be applied to the touch screen 100 shown in FIG. 1A to solve the interference with the environment light beam relatively tilting to the displaying surface 210.

It should be noted that, in other embodiments, the order of the first sub-unit time U1, the second sub-unit time U2, and the third sub-unit time U3 may be changed to another possible order.

FIG. 4B is a flowchart of a control method of the touch module shown in FIG. 3A. Referring to FIG. 3A, FIG. 4A, and FIG. 4B, the control method of the present embodiment is similar to the said control method as illustrated in FIG. 2B, and the difference between these two control methods is described as below. In the present embodiment, step S110′ further includes step S116. In step S116, the first light source 312a and the second light source 312b are controlled to stay at the OFF state in the third sub-unit time U3. Moreover, in the present embodiment, step S120′ includes steps S122 and S124. In step S122, the image brightness sensed by the first image sensor 314a in the third sub-unit time U3 is subtracted from the image brightness sensed by the first image sensor 314a in the first sub-unit time U1 to obtain a first touch image. Furthermore, the image brightness sensed by the second image sensor 314b in the third sub-unit time U3 is subtracted from the image brightness sensed by the second image sensor 314b in the second sub-unit time U2 to obtain a second touch image. Moreover, after step S122, step S124 is performed. the position of the touch object 50 relative to the displaying surface is determined according to the first touch image and the second touch image.

Through the said subtraction of the two image brightness, the image due to the environment light beam 72 is eliminated, so that the exact position of the touch object 50 is obtained without being interfered with the environment light beam 72. The said control method may be applied to the projection screen. Since the projection screen has no frame, it is easily interfered with the environment light beam 72. Accordingly, the said issues can be effectively solved in the control method of the present embodiment. Furthermore, the control method of the present embodiment may be applied to the touch screen 100 shown in FIG. 1A to solve the interference with the environment light beam relatively tilting to the displaying surface 210.

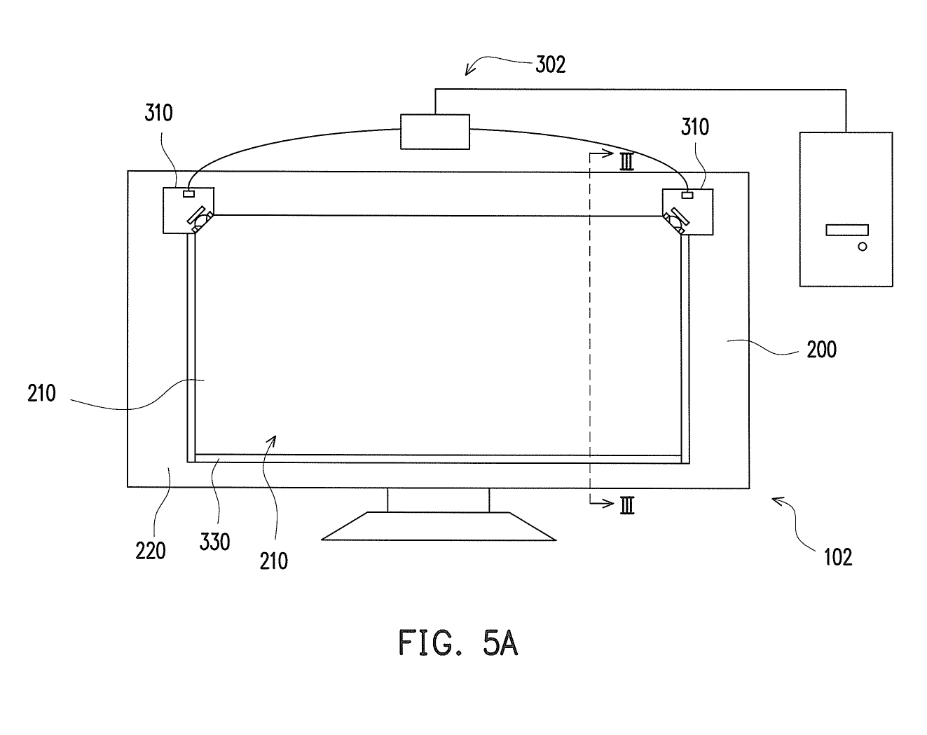

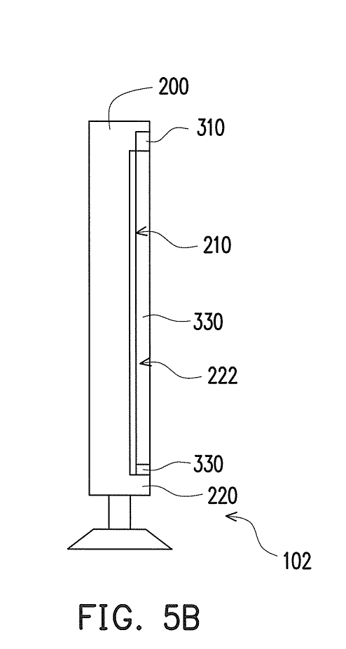

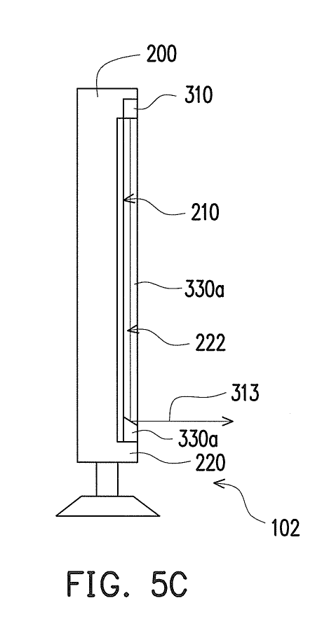

FIG. 5A is a front view of a touch screen and an operating platform according to another embodiment of the present invention. FIG. 5B is a schematic cross-sectional view of the touch screen in FIG. 5A along line III-III. Referring to FIG. 5A and FIG. 5B, the touch screen 102 of the present embodiment is similar to the said touch screen 100 (as illustrated in FIG. 1A and FIG. 1B), and the difference between these two touch screens is described as below. In the present embodiment, the touch module 302 further includes at least one absorbing bar 330 which is disposed on at least one edge of the displaying surface 210. For example, the number of the absorbing bars 330 is three, and they are respectively disposed on the three edges of the displaying surface 210. The absorbing bars 330 can absorb the light beam 313 from the light source 212 which should illuminate on the frame 220. Accordingly, it is avoided that the light beam 313 reflected by the frame 220 interferes with the image sensor 314 of the different touch unit 310. In another embodiment, the absorbing bars 330 may be replaced with light-turning bars 330a, as shown in FIG. 5C. The light-turning bars 330a are adapted to reflect the light beam 313 to a direction far away from the displaying surface 210. Accordingly, it is avoided that the light beam 313 reflected by the frame 220 interferes with the image sensor 314 of the different touch unit 310.

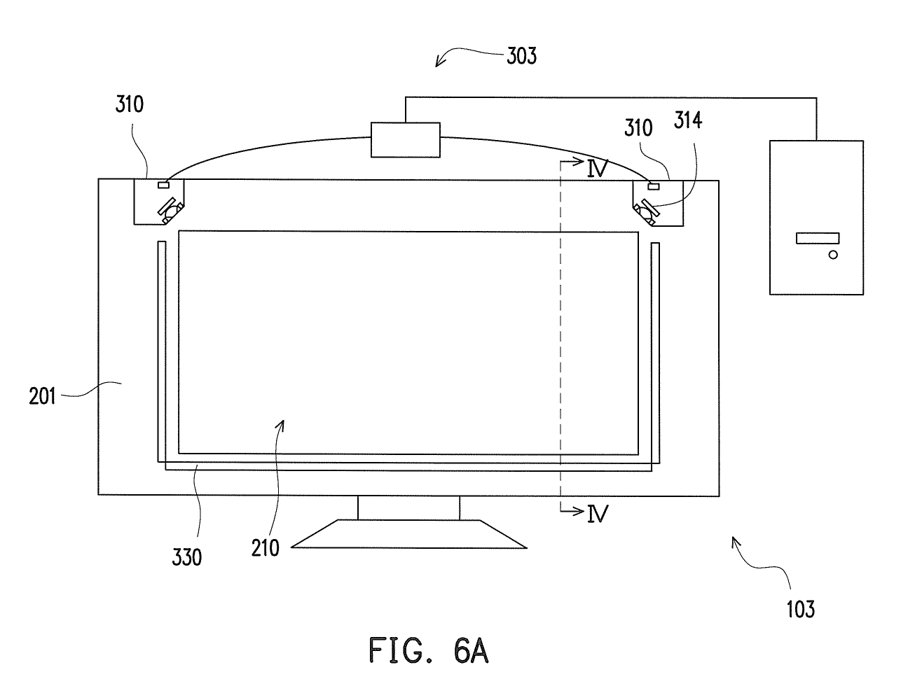

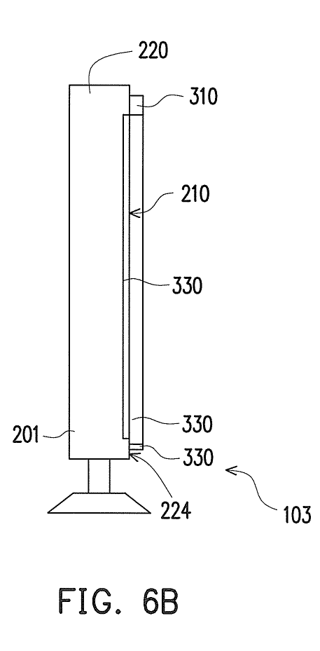

FIG. 6A is a front view of a touch screen and an operating platform according to another embodiment of the present invention. FIG. 6B is a schematic cross-sectional view of the touch screen in FIG. 6A along line IV-IV. Referring to FIG. 6A and FIG. 6B, the touch screen 103 of the present embodiment is similar to the said touch screen 102 (as illustrated in FIG. 5A and FIG. 5B), and the difference between these two touch screens is described as below. The display 200 of the touch screen 102 is replaced with the display 201 in FIG. 3B, so that the touch screen 103 is provided in the present invention. Moreover, the absorbing bars 330 of the touch module 302 shown in FIG. 5A and FIG. 5B are disposed in a recess 222 surrounded by the frame 220. However, the absorbing bars 330 of the touch module 303 of the present embodiment are disposed on a front surface 224 of the frame 220. The absorbing bars 330 can absorb the environment light beam parallel to the displaying surface 210, so that the sensing result of the image sensor 314 Accordingly, it is avoided that the environment light beam interferes with the sensing result of the image sensor 314.

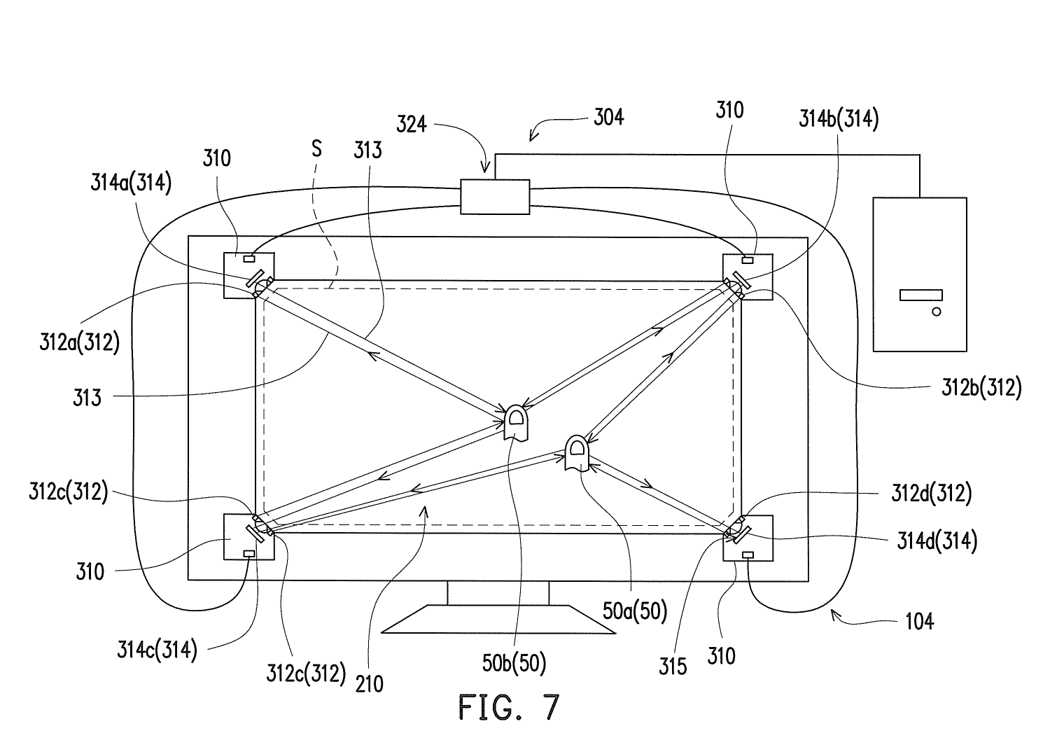

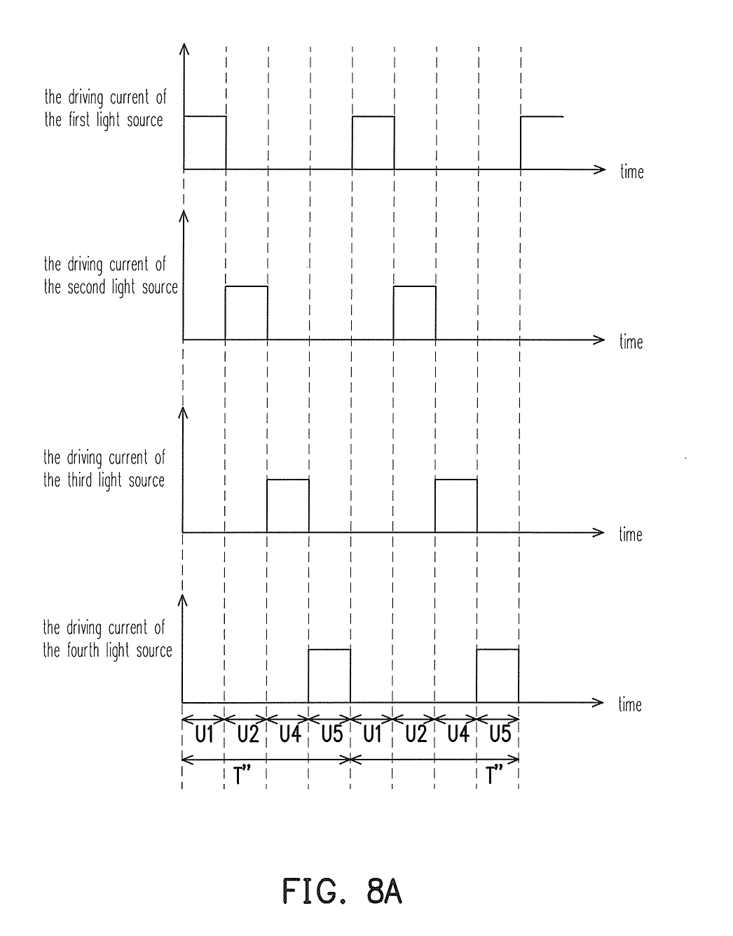

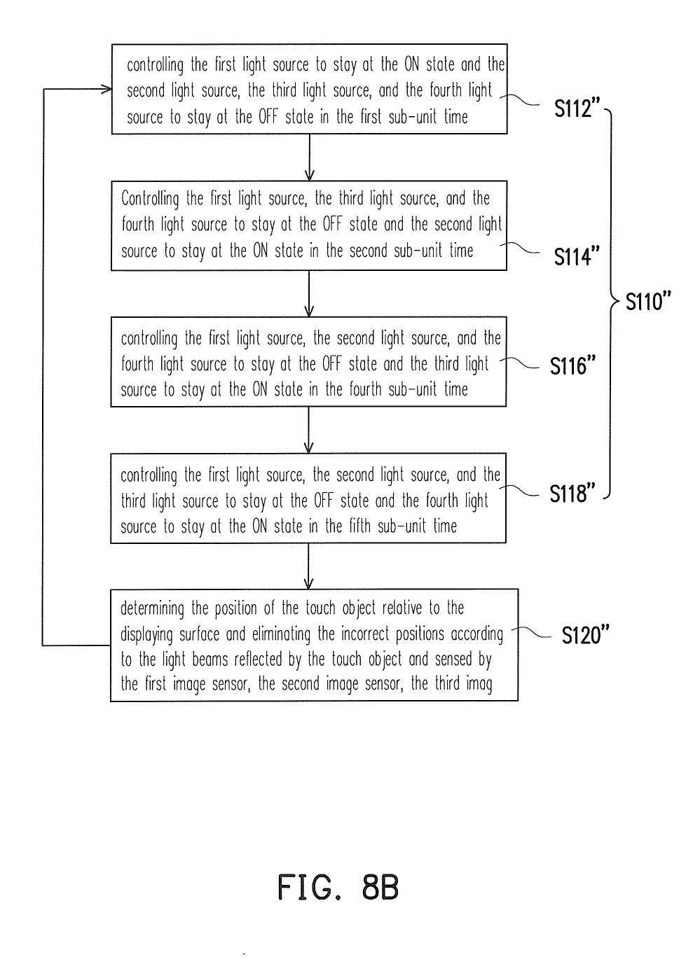

FIG. 7 is a front view of a touch screen and an operating platform according to another embodiment of the present invention. FIG. 8A is a driving period distribution of the control unit in FIG. 7. Referring to FIG. 7 and FIG. 8A, the touch screen 104 of the present embodiment is similar to the said touch screen 100 in FIG. 1A, and the difference between these two touch screens is described as below. In the present embodiment, the touch screen 104 has two additional touch modules 310. Specifically, the touch module 310 further includes a third image sensor 314c and a fourth image sensor 314d which are respectively disposed at a fifth position and a sixth position beside the displaying surface 210, such as the positions shown in FIG. 7. In the present embodiment, sensing surfaces 315 of the third image sensor 314c and the fourth image sensor 314d face to the sensing space S. In the present embodiment, the four touch modules 310 are respectively disposed at four corners of the displaying surface 210. However, in other embodiments, the touch modules 310 may be respectively disposed at other suitable positions.

The light sources 312 further include at least one third light source 312c, e.g. two third light sources 312c shown in FIG. 7, and at least one fourth light source 312d, e.g. two fourth light sources 312d shown in FIG. 7, which are respectively disposed at a seventh position and an eighth position, e.g. the positions shown in FIG. 7, beside the displaying surface 210. Each of the unit times T″ further includes a fourth sub-unit time U4 and a fifth sub-unit time U5. The control unit 324 is adapted to further control the third light source 312c and the fourth light source 312d to stay at the OFF state in the first sub-unit time U1. The control unit 324 is adapted to further control the third light source 312c and the fourth light source 312d to stay at the OFF state in the second sub-unit time U2. The control unit 324 is adapted to control the third light source 312c to stay at the ON state and the first light source 312a, the second light source 312b, and the fourth light source 312d to stay at the OFF state in the fourth sub-unit time U4. The control unit 324 is adapted to control the fourth light source 312d to stay at the ON state and the first light source 312a, the second light source 312b, and the third light source 312c to stay at the OFF state in the fifth sub-unit time U5. In the present embodiment, the first image sensor 314a, the second image sensor 314b, the third image sensor 314c, and the fourth image sensor 314d are respectively turned on and sense the images during the first sub-unit time U1, the second sub-unit time U2, the third sub-unit time U3, and the fourth sub-unit time U4. However, in other embodiments, the first image sensor 314a, the second image sensor 314b, the third image sensor 314c, and the fourth image sensor 314d may be maintained at the ON state all the time in each of the unit times T″.

In the present embodiment, the number of the touch objects 50, for example, is two. That is, the touch object 50a and the touch object 50b are exemplary herein. When the touch objects 50 are simultaneously located in the sensing space S in at least one of the unit times T″, the touch images sensed by the first image sensor 314a, the second image sensor 314b, the third image sensor 314c, and the fourth image sensor 314d each have at least one reflex point in the unit times T″. For example, since the first image sensor 314a, the touch object 50b, the touch object 50a, and the fourth image sensor 314d are arranged in the same straight line, the first image sensor 314a simply senses the reflex point formed by the touch object 50b instead of the reflex point formed by the touch object 50a. On the contrary, the fourth image sensor 314d simply senses the reflex point formed by the touch object 50a instead of the reflex point formed by the touch object 50b. Accordingly, each of the first image sensor 314a and the fourth image sensor 314d simply senses one reflex point. Furthermore, the touch images sensed by at least two of the first image sensor 314a, the second image sensor 314b, the third image sensor 314c, and the fourth image sensor 314d each have two reflex points For example, the second image sensor 314b and the third image sensor 314c each sense two reflex points in the present embodiment. As a result, two of the four one-dimensional coordinate signals respectively outputted by the first image sensor 314a, the second image sensor 314b, the third image sensor 314c, and the fourth image sensor 314d respectively include two one-dimensional coordinates, and the other two thereof respectively include an one-dimensional coordinate. Accordingly, more than two positions of the touch objects 50 are obtained but not consistent with the practical situation. Generally, the four one-dimensional coordinate signals may respectively include two one-dimensional coordinates, so that a lot of positions inconsistent with the practical situation are obtained.

In order to solve the said issue, the control unit 324 is adapted to compare the positions of the reflex points in the touch images to eliminate the positions of the touch objects 50 relative to the displaying surface 210 which do not exist and determine the positions of the touch objects 50 relative to the displaying surface 210. In other words, after receiving the four one-dimensional coordinate signals, the control unit 324 calculates the data of the plurality of the positions according thereto. Next, the conjunction of the data is viewed as the practical position, and the others are eliminated. As a result, the touch screen 104 and the touch module 304 of the present embodiment can exactly determine the positions of the two touch objects 50. Accordingly, multi-touch is provided. Moreover, along with the increase of touch points, e.g. more than three touch points, more touch units 310 are adopted in other embodiments of the present invention, so that the positions of the touch points can be exactly determined.

It should be noted that, the touch screen 104 and the touch module 304 of the present embodiment are not only adapted to determine the positions of the two touch objects 50. If only one touch object 50 enters the sensing space S, the control unit 324 simply calculates the data of one position according to the four one-dimensional coordinate signals outputted by the four image sensors 314. Accordingly, it is not required to eliminate the data of the position inconsistent with the practical situation for the control unit. Furthermore, in another embodiment, the four touch units 310 may be grouped into two sets. For example, the upper two touch units are grouped into one set in FIG. 7, and the lower two touch units are grouped into the other set in FIG. 7. Moreover, in the first sub-unit time U1, the light sources 312a and 312b of the upper two touch units 310 are simultaneously turned on, but the light sources 312c and 312d of the lower two touch units 310 are simultaneously turned off. Next, in the second sub-unit time U2, the light sources 312c and 312d of the lower two touch units 310 are simultaneously turned on, but the light sources 312a and 312b of the upper two touch units 310 are simultaneously turned off. By arranging the positions of the light sources 312, the light beams 313 emitted by the light sources 312a and 312b of the upper two touch units 310 may not or little directly enter the image sensors 314b and 314a respectively, and the light beams 313 emitted by the light sources 312c and 312d of the lower two touch units 310 may not or little directly enter the image sensors 314d and 314c respectively, either. Accordingly, the exact determination for the positions of the touch objects 50 is also provided.

FIG. 8B is a flowchart of a control method of the touch module shown in FIG. 7. Referring to FIG. 7, FIG. 8A, and FIG. 8B, the control method of the present embodiment is similar to the said control method as illustrated in FIG. 2B, and the difference between these two control methods is described as below. In step S112″ of step S110″, the third light source 312c and the fourth light source 312d are further controlled to stay at the OFF state in the first sub-unit time U1. In step S114″, the third light source 312c and the fourth light source 312d are further controlled to stay at the OFF state in the second sub-unit time U2. Moreover, step S110″ further includes steps S116″ and S118″. In step S116″, the third light source 312c is controlled to stay at the ON state and the first light source 312a, the second light source 312b, and the fourth light source 312d are controlled to stay at the OFF state in the fourth sub-unit time U4. In step S118″, the fourth light source 312d is controlled to stay at the ON state and the first light source 312a, the second light source 312b, and the third light source 312d are controlled to stay at the OFF state in the fifth sub-unit time U5. In the present embodiment, the number of the touch objects, for example, is two. When the touch objects 50 are simultaneously located in the sensing space S in at least one of the unit times T″, the touch images sensed by the first image sensor 314a, the second image sensor 314b, the third image sensor 314c, and the fourth image sensor 314d respectively have at least one reflex point, and at least two of the touch images sensed by the first image sensor 314a, the second image sensor 314b, the third image sensor 314c, and the fourth image sensor 314d respectively have two reflex points in the unit times T″. Accordingly, in the present embodiment, step S120″ further includes a step of comparing positions of the reflex points in the touch images to eliminate the positions of the touch objects 50 relative to the displaying surface 210 which do not exist and determine the positions of the touch objects 50 relative to the displaying surface 210. As a result, the positions of the two touch objects 50 can be exactly determined in the control method of the present embodiment.

The number of the adopted touch units 310 is two or four, but the present invention is not limited thereto. In other embodiment, another number of the touch units 310 is adopted. Another embodiment is given for illustration below.

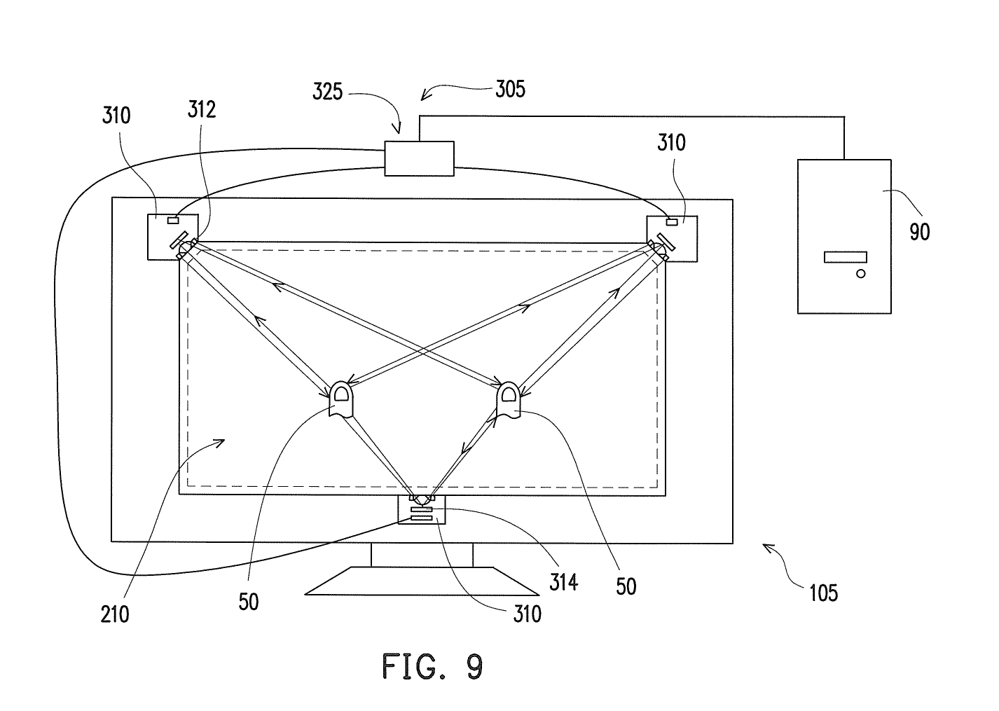

FIG. 9 is a front view of a touch screen and an operating platform according to another embodiment of the present invention. Referring to FIG. 9, the touch screen 105 of the present embodiment is similar to the said touch screen 104 in FIG. 7, and the difference between these two touch screens is described as below. In the present embodiment, the touch modules 105 simply have three touch units 310, and one of the three touch units 310 is disposed at the bottom edge of the displaying surface 210. The control unit 325 and the control method of the present embodiment is similar to the said embodiment as illustrated in FIG. 7, FIG. 8A, and FIG. 8B. For example, the control unit 325 drives the light sources 312 of the three touch units 310 by turns. Moreover, the control unit 325 compares the bright spots captured by the image sensors 314 of the three touch units 310 to eliminate the data of the incorrect positions. Accordingly, the exact positions of the two touch objects 50 are obtained. Furthermore, three touch units 310 are adopted in the present embodiment, so that it enhances accuracy of determining the position of the single touch object 50.

To sum up, in the touch screen, the touch module, and a control method of the touch module of the embodiments consistent with the present invention, the image sensor is used to capture the bright spot, i.e. the light beam reflected by the touch object. Compared with the touch module in which capturing the dark spot, i.e. the light shading spot, is adopted, and the good back light source is formed by disposing the reflecting bars and the light emitting bars on the edges of the displaying surface, the reflecting bars and the light emitting bars are not required by the touch screen and the touch module of the embodiments consistent with the present invention, so that the structures thereof are simpler. Accordingly, it can reduce cost of the touch screen and the touch module, and the touch screen is beautiful.

Moreover, the light sources are controlled to stay at the ON state by turns in the touch module, the touch screen, and the control method thereof in the embodiments consistent with the present invention. Accordingly, it is avoided that the image sensors are interfered with light beams emitted by unnecessary light sources. Therefore, the touch module, the touch screen, and the control method thereof in the embodiments consistent with the present invention have low failure rate.

Although the present invention has been described with reference to the above embodiments, it is apparent to one of the ordinary skill in the art that modifications to the described embodiments may be made without departing from the spirit of the invention. Accordingly, the scope of the invention will be defined by the attached claims not by the above detailed descriptions.

What is claimed is:

1. A touch module, adapted to a display for making the display have a touch function, the display having a displaying surface, the touch module comprising:
a first image sensor disposed at a first position beside the displaying surface;
a second image sensor disposed at a second position beside the displaying surface; and
a control unit electrically connected to the first image sensor and the second image sensor, wherein when at least one touch object enters a sensing space in front of the displaying surface, the first image sensor and the second image sensor sense a light beam reflected by the at least one touch object, and the control unit is adapted to determine a position of the at least one touch object relative to the displaying surface according to the light beam reflected by the at least one touch object and sensed by the first image sensor and the second image sensor.

2. The touch module as claimed in claim 1, further comprising at least one light source disposed beside the displaying surface and adapted to emit the light beam entering the sensing space.

3. The touch module as claimed in claim 2, wherein the at least one light source comprises a first light source and a second light source respectively disposed at a third position and a fourth position beside the displaying surface, the control unit is adapted to continuously control the first light source and the second light source in a plurality of continuous unit times, each of the unit times comprises a first sub-unit time and a second sub-unit time, the control unit is adapted to control the first light source to stay at an ON state and the second light source to stay at an OFF state in the first sub-unit time, and the control unit is adapted to control the first light source to stay at the OFF state and the second light source to stay at the ON state in the second sub-unit time.

4. The touch module as claimed in claim 3, wherein the control unit is adapted to control the first image sensor to stay at the ON state and the second image sensor to stay at the OFF state in the first sub-unit time, and the control unit is adapted to control the first image sensor to stay at the OFF state and the second image sensor to stay at the ON state in the second sub-unit time.

5. The touch module as claimed in claim 3, wherein each of the unit times further comprises a third sub-unit time, the control unit is adapted to control the first light source and the second light source to stay at the OFF state in the third sub-unit time, the control unit is adapted to subtract an image brightness sensed by the first image sensor in the third sub-unit time of each of the unit times from an image brightness sensed by the first image sensor in the first sub-unit time of the corresponding unit time to obtain a first touch image, the control unit is adapted to subtract an image brightness sensed by the second image sensor in the third sub-unit time of each of the unit times from an image brightness sensed by the second image sensor in the second sub-unit time of the corresponding unit time to obtain a second touch image, and the control unit determines the position of the at least one touch object relative to the displaying surface according to the first touch image and the second touch image.

6. The touch module as claimed in claim 3, wherein the third position and the fourth position are respectively located at two neighboring corners of the displaying surface.

7. The touch module as claimed in claim 6, wherein the first position and the third position are respectively located beside a same corner of the displaying surface, and the second position and the fourth position are respectively located beside a same corner of the displaying surface.

8. The touch module as claimed in claim 3, further comprising a third image sensor and a fourth image sensor respectively disposed at a fifth position and a sixth position beside the displaying surface, and sensing surfaces of the third image sensor and the fourth image sensor facing to the sensing space, wherein the at least one light source further comprises a third light source and a fourth light source respectively disposed at a seventh position and an eighth position beside the displaying surface, each of the unit times further comprises a fourth sub-unit time and a fifth sub-unit time, the control unit is adapted to control the third light source and the fourth light source to stay at the OFF state in the first sub-unit time, the control unit is adapted to control the third light source and the fourth light source to stay at the OFF state in the second sub-unit time, the control unit is adapted to control the third light source to stay at the ON state and the first light source, the second light source, and the fourth light source to stay at the OFF state in the fourth sub-unit time, and the control unit is adapted to control the fourth light source to stay at the ON state and the first light source, the second light source, and the third light source to stay at the OFF state in the fifth sub-unit time.

9. The touch module as claimed in claim 8, wherein the at least one touch object is two touch objects, when the touch objects are simultaneously located in the sensing space in at least one of the unit times, the touch images sensed by the first image sensor, the second image sensor, the third image sensor, and the fourth image sensor each have at least one reflex point, and the touch images sensed by at least two of the first image sensor, the second image sensor, the third image sensor, and the fourth image sensor each have two reflex points in the at least one of the unit times, and the control unit is adapted to compare positions of the reflex points in the touch images to eliminate the positions of the touch objects relative to the displaying surface which do not exist and determine the positions of the touch objects relative to the displaying surface.

10. The touch module as claimed in claim 3, wherein the first image sensor and the second image sensor are maintained at the ON state all the time in each of the unit times.

11. The touch module as claimed in claim 1, wherein the first position and the second position are respectively located at two neighboring corners of the displaying surface.

12. The touch module as claimed in claim 1, further comprising at least one absorbing bar or at least one light-turning bar disposed on at least one edge of the displaying surface, wherein the at least one light-turning bar is adapted to reflect the light beam to a direction away from the displaying surface.

13. A touch module, adapted to a display, for making the display have a touch function, the display having a displaying surface, the touch module comprising:
a first image sensor disposed at a first position beside the displaying surface;
a second image sensor disposed at a second position beside the displaying surface;
a first light source disposed at a third position beside the displaying surface and adapted to emit a light beam entering a sensing space in front of the displaying surface;
a second light source disposed at a fourth position beside the displaying surface and adapted to emit a light beam entering the sensing space; and
a control unit electrically connected to the first light source, the second light source, the first image sensor, and the second image sensor, wherein the control unit is adapted to continuously control the first light source and the second light source in a plurality of continuous unit times, each of the unit times comprises a first sub-unit time and a second sub-unit time, the control unit is adapted to control the first light source to stay at an ON state and the second light source to stay at an OFF state in the first sub-unit time, the control unit is adapted to control the first light source to stay at the OFF state and the second light source to stay at the ON state in the second sub-unit time, when at least one touch object enters the sensing space, the first image sensor and the second image sensor sense images of the at least one touch object, and the control unit is adapted to determine a position of the at least one touch object relative to the displaying surface according to the images sensed by the first image sensor and the second image sensor.

14. The touch module as claimed in claim 13, wherein the control unit is adapted to control the first image sensor to stay at the ON state and the second image sensor to stay at the OFF state in the first sub-unit time, and the control unit is adapted to control the first image sensor to stay at the OFF state and the second image sensor to stay at the ON state in the second sub-unit time.

15. The touch module as claimed in claim 13, wherein each of the unit times further comprises a third sub-unit time, the control unit is adapted to control the first light source and the second light source to stay at the OFF state in the third sub-unit time, the control unit is adapted to subtract an image brightness sensed by the first image sensor in the third sub-unit time of each of the unit times from an image brightness sensed by the first image sensor in the first sub-unit time of the corresponding unit time to obtain a first touch image, the control unit is adapted to subtract an image brightness sensed by the second image sensor in the third sub-unit time of each of the unit times from an image brightness sensed by the second image sensor in the second sub-unit time of the corresponding unit time to obtain a second touch image, and the control unit determines the position of the at least one touch object relative to the display according to the first touch image and the second touch image.

16. The touch module as claimed in claim 13, wherein the third position and the fourth position are respectively located at two neighboring corners of the displaying surface.

17. The touch module as claimed in claim 16, wherein the first position and the third position are respectively located beside a same corner of the displaying surface, and the second position and the fourth position are respectively located beside a same corner of the displaying surface.

18. The touch module as claimed in claim 13, wherein the first image sensor and the second image sensor are maintained at the ON state all the time in each of the unit times.

19. A touch screen, comprising:
a display having a displaying surface;
at least two touch units disposed beside the displaying surface, and each of the touch units comprising:
a light source disposed beside the displaying surface and adapted to emit a light beam entering a sensing space in front of the displaying surface; and
an image sensor disposed beside the displaying surface, and a sensing surfaces of the image sensor facing to the sensing space, wherein the image sensor is adapted to capture a bright spot in the sensing space and generate an image signal; and
a control unit electrically connected to the light sources and the image sensors, wherein the control unit is adapted to receive the image signals from the image sensors and determine a position of the bright spot relative to the displaying surface according to the image signals.

20. The touch screen as claimed in claim 19, wherein the control unit is adapted to drive the light sources of the touch units by turns.

21. The touch screen as claimed in claim 20, wherein after driving the light source of one of the touch units and before driving the light source of another one of the touch units, the control unit is adapted to maintain the light sources of the touch units at an OFF state, the control unit is adapted to subtract an image brightness sensed by the image sensor of each of the touch units while the light source of the same touch unit is maintained at the OFF state from an image brightness sensed by the same image sensor thereof while the same light source is driven to obtain a touch image, and the control unit determines the position of the bright spot relative to the displaying surface according to the touch image.

22. The touch screen as claimed in claim 19, wherein the control unit comprises:
at least two signal processors electrically connected to the image sensors of the touch units respectively, wherein each of the signal processors is adapted to determine the position of the bright spot according to the image sensed by the corresponding image sensor and generate a one-dimensional coordinate signal; and
a back-end processor electrically connected to the signal processors, wherein the back-end processor is adapted to receive the one-dimensional coordinate signals generated by the signal processors and determine the position of the bright spot relative to the displaying surface according to the one-dimensional coordinate signals.

23. The touch screen as claimed in claim 19, wherein the control unit is adapted to control the image sensor to repeatedly capture the bright spot in the sensing space and determine a position change of the bright spot according thereto.
